(19) United States
(12) Patent Application Publication
(10) Pub. No.: US 2009/0255211 A1
(43) Pub. Date: Oct. 15, 2009

(54) Method and means for producing a concrete block

(76) Inventor: Ryan Collison, Lincoln, NE (US)

Correspondence Address: THOMTE LAW OFFICE, L.L.C., 2120 S. 72ND STREET, SUITE 1111, OMAHA, NE, 68124, US

(21) Appl. No.: 12/082,733

(22) Filed: Apr. 14, 2008

(51) Int. Cl. E04B 1/04; B28B 7/34

(52) U.S. Cl. 52/745.19; 249/134

(57) ABSTRACT

A method and means for producing a concrete block through the use of a urethane form which includes a bottom wall, end walls and side walls with the inside surface of the bottom wall having grooves, indentations and ribs molded therein so that the resultant face of the concrete block will have an irregular surface and brick-like members appearing thereon. The method of this invention also involves the use of placing one or more coloring agents in the cavities of the urethane form so that the face of the concrete block will have a more realistic appearance.

### BACKGROUND OF THE INVENTION

1. Field of the Invention

This invention relates to a method and means for producing a concrete block and more particularly to a method and means for producing a concrete block wherein a urethane form is used with the inside surface of the bottom wall of the urethane form having an irregular surface molded therein so that the face of the concrete block will have an irregular surface. Even more particularly, the method of this invention involves the use placing coloring agents in the cavities formed in the inside surface of the bottom wall of the urethane mold so that the resultant concrete blocks will have a natural looking appearance.

2. Description of the Related Art

Dry-cast concrete mixes, also known as no-slump mixes, are used in precast plants to produce a large number of precast concrete products. Dry-cast mixes have the consistency of slightly wetted soil. Of particular interest to precasters is the increased production efficiency due to the very early product handling strengths and the ability to immediately remove and reuse forms.

Many types of metal forms have been used in the manufacture of concrete blocks but the use of metal forms makes it difficult to achieve the desired face appearance of the concrete blocks due to the difficulty in forming indentations, ridges, brick-shaped portions, etc. therein.

### SUMMARY OF THE INVENTION

A method and means is provided for producing a concrete block. The method of this invention comprises the following steps: (1) providing a urethane form including an irregular surfaced bottom wall with end and side walls extending upwardly therefrom with each of the walls having an inner surface and with each of the end and side walls having an upper end; (2) creating a plurality of upstanding ribs on the inner surface of the bottom wall of the form to define cavity sections therein; (3) placing one or more coloring agents in some or all of the cavity sections; (4) sprinkling or spraying water onto the coloring agents; (5) positioning the urethane form in a dry-casting machine; (6) positioning a hollow mold box, having open upper and lower ends, around the urethane form so that the upper end of the mold box is positioned above the upper ends of the end and side walls of the urethane form and so that the lower end of the mold box is positioned below the upper ends of the end and side walls of the urethane form; (7) placing dry-cast concrete into the mold box and the urethane form; (8) compacting and vibrating the dry-cast concrete in the mold box and the urethane form; (9) removing the mold box from the compacted concrete and the urethane form; (10) removing the urethane form and the dry-cast concrete therein from the dry-casting machine; (11) allowing the dry-cast concrete to cure while in the urethane form; and (12) removing the concrete block from the urethane form.

It is therefore a principal object of the invention to provide an improved method and means for producing a concrete block.

Still another object of the invention is to provide a urethane form for use in the production of a concrete block.

Still another object of the invention is to provide a urethane form which includes a bottom wall having an inside surface wherein the inside surface of the bottom is provided with ridges, indentations and ribs as desired so that the face of the block will have an irregular appearance with rectangular shaped face portions if so desired.

Still another object of the invention is to provide a method and means for producing a concrete block wherein the face portion of the block will have different colors provided thereon to create a more natural appearance.

Still another object of the invention is to provide a method and means for producing a dry-cast concrete block.

These and other objects will be apparent to those skilled in the art.

### BRIEF DESCRIPTION OF THE DRAWINGS

FIG. 1 is a top perspective view of one form of the urethane form utilized in this invention:

FIG. 2 is a perspective view of a concrete block produced by the method of this invention:

FIG. 3 is an exploded perspective view illustrating a pair of urethane forms being positioned on a supporting form prior to the forms being introduced into a dry-casting machine:

FIG. 4 is a perspective view illustrating a pair of block members residing in the urethane forms on opposite sides of the supporting form after having been removed from the dry-casting machine:

FIG. 5 is an exploded perspective view illustrating the manner in which the concrete blocks, while still in the urethane forms, are removed from the supporting form:

FIGS. 6-11 are schematic views illustrating the steps of this method:

FIG. 12 is a sectional view illustrating a pair of the urethane forms being positioned in a dry-casting machine with concrete being added thereto.

### DESCRIPTION OF THE PREFERRED EMBODIMENT

The numeral 10 refers to the urethane form or form liner which is a critical part of this invention. Form 10 is generally rectangular in shape but could be square if so desired. Form 10 is comprised of urethane which is a Polytek® 75-70 or 75-80 material. Form 10 includes a bottom wall 12, end walls 14 and 16, and side walls 18 and 10. Each of the walls 12, 14, 16, 18 and 20 has inside surfaces. The inside surface of bottom wall 12 has an irregular surface 22 molded therein which has indentations 24 and ridges 26. If the concrete block which is to be formed by the form 10 to provide a plurality of generally rectangular face portions, a plurality of upstanding ribs or partitions 28 are molded with the form 10 and will extend upwardly from the inside surface of bottom wall 12 to define a plurality of generally rectangular cavities 29. The form 10 will be used as disclosed hereinafter to create a concrete block 30 having a front face 32, upper surface 34, lower surface 36 and back face or surface 38. The form 10 illustrated in FIG. 1 will create an irregular, naturally appearing front face 32 with a plurality of rectangular face portions 40 which are generally rectangular in appearance. In some cases, the ribs 28 may be omitted so that the face portion 40 will not define rectangular sections but will have an uninterrupted face portion having an irregular appearance.

Although the process to be described hereinafter may be used to produce a pair of blocks 30, the process may be utilized to produce a single block 30 during each cycle of the formation of the block 30. When the process of this invention is used to produce a pair of blocks 30 during each cycle, a supporting form 42 will be used which includes an upstanding portion 44 having opposite surfaces 46 and 48 and an upper end 50. A pair of base members 50 and 52 extend horizontally from the lower end of the upstanding portion 44. If the underside or bottom of the block 30 is to have cavities formed therein, protrusions 53 will be provided which extend outwardly from surfaces 46 and 48.

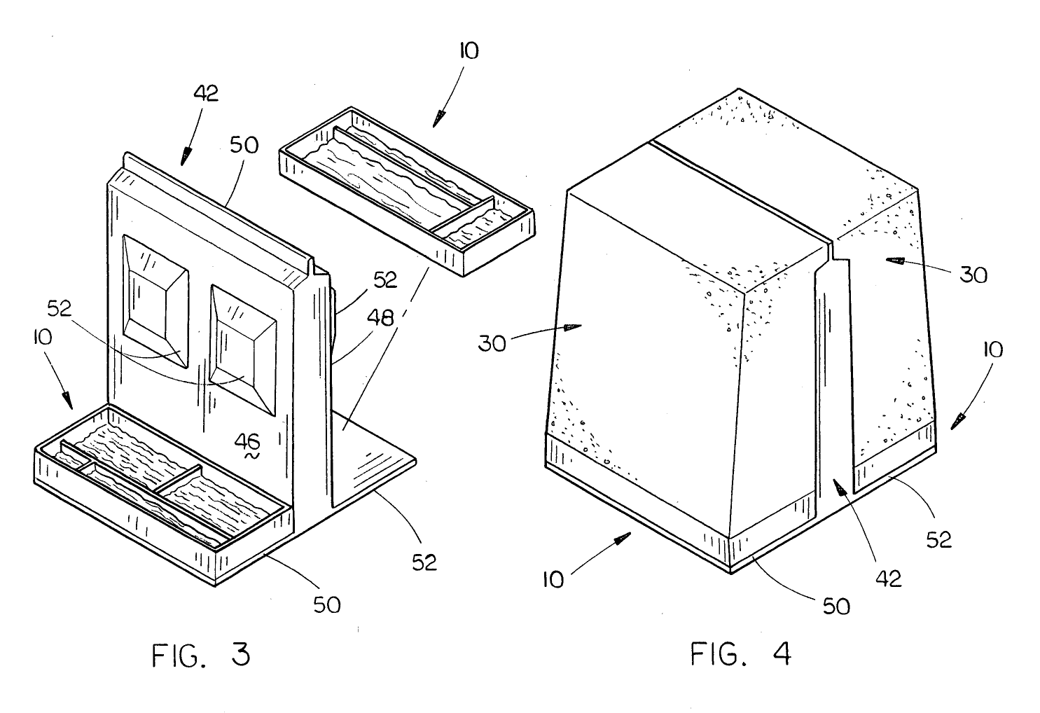

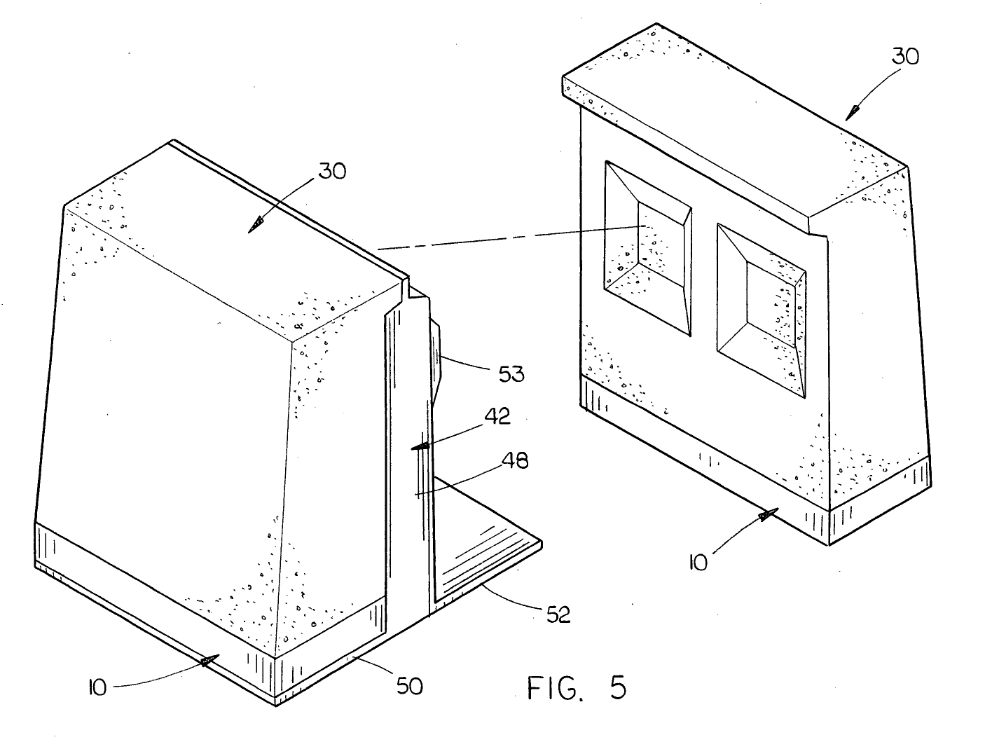

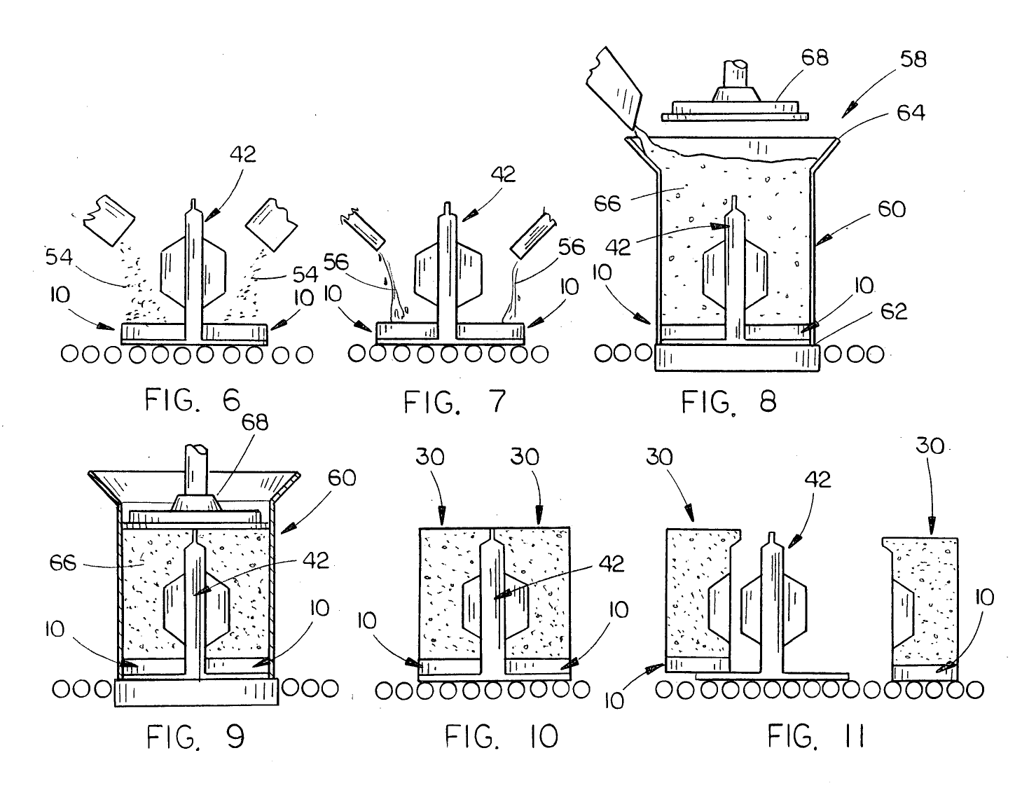

Assuming that the process or method of this invention will be used to produce a pair of blocks 30 during each cycle, a pair of the forms 10 will be placed on the base members 50 and 52 as seen in FIG. 3. As seen in FIG. 6, a coloring agent or agents 54 will then be sprinkled or deposited into the cavities 29. Normally, at least two different coloring agents will be sprinkled into different cavities 29 of the bottom wall of the form 10 to make the face portion 32 of the block 30 appear more natural. After the coloring agents 54 have been sprinkled into the cavities 29, a small amount of water 56 will be sprayed or sprinkled into the cavities 29 (FIG. 7) to cause the color agent or agents to become paste like.

The forms 10 and the form 42 will then be moved into a dry-casting machine referred to generally by the reference numeral 58. A hollow mold box 60, which has the same cross-sectional configuration as the form 10, is then lowered downwardly so that the lower end 62 of mold box 60 enhances the end walls and the outer side walls of the forms 10 as seen in FIG. 8. As seen in FIG. 8, the upper end 64 of the mold box is disposed at a considerable height above the upper ends of the end and side walls of the forms 10.

A dry-cast concrete 66 comprising water, sand, gravel and Portland cement is then poured into the upper end of the mold box 60 as seen in FIG. 8. A compaction head or plunger 68 is then lowered into the mold box 60 to compress or compact the concrete 66. It is preferred that the concrete 66 also be vibrated at the same time utilizing conventional vibration techniques. The compaction head 68 is lowered until it reaches the upper end of the form 42 as seen in FIG. 9.

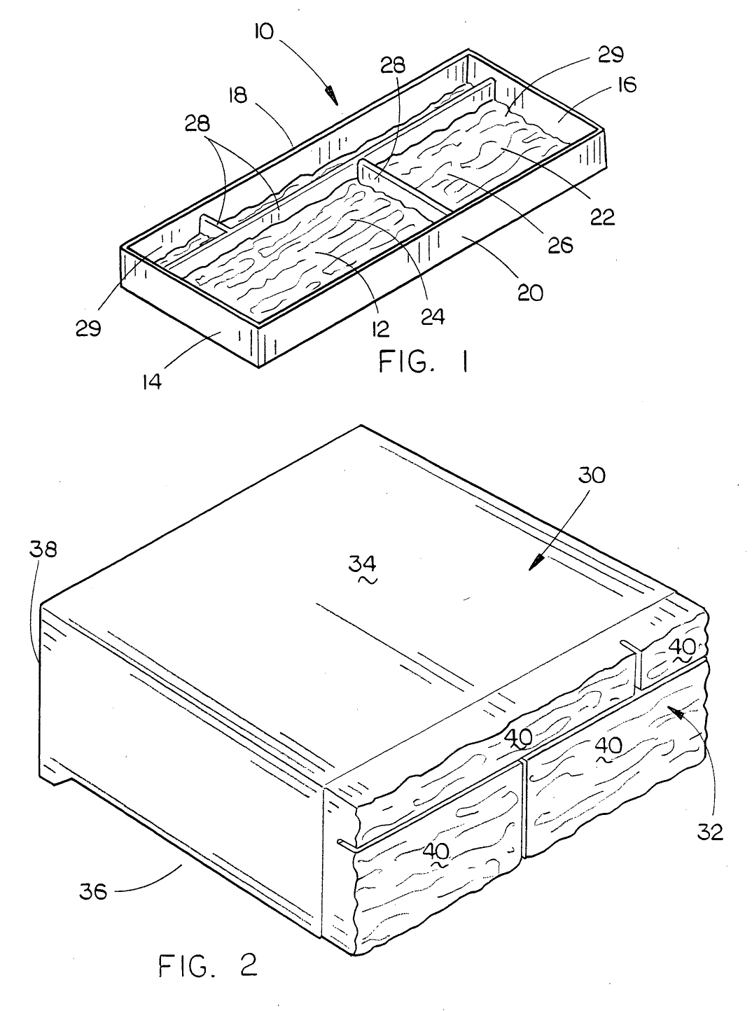

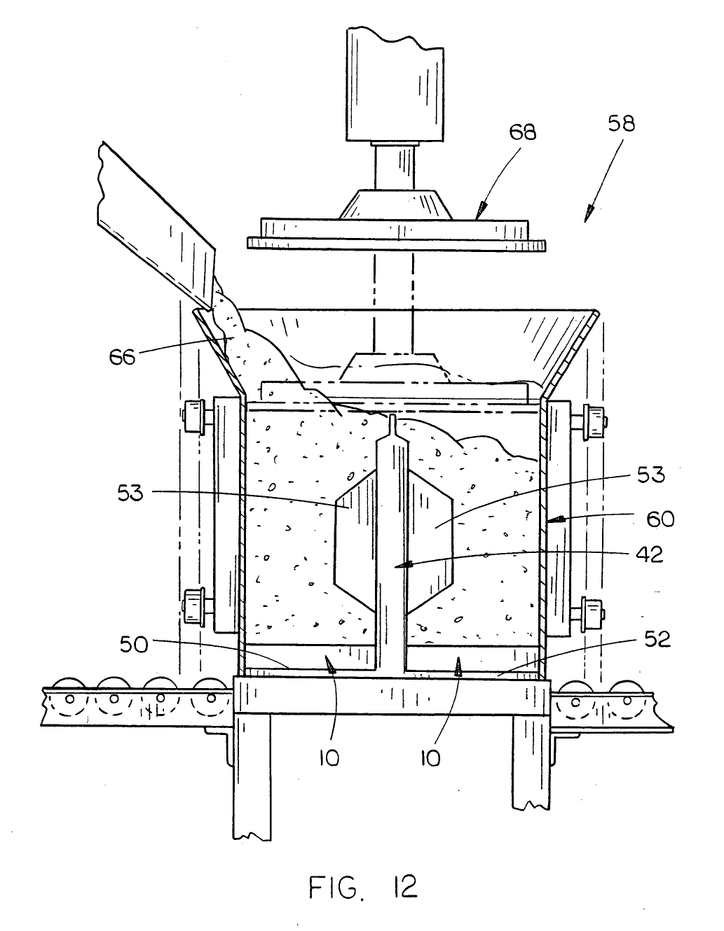

After the concrete 66 has been compacted and vibrated in the step of FIG. 9, the compactor head 68 is raised upwardly and the mold box 60 is pulled upwardly from the blocks. The assembly is then removed from the machine 58 (FIG. 10). The blocks 30, while still in the forms 10, are then separated from the supporting mold 42 and are moved to a location for curing. After the blocks 30 have cured, they are removed from the molds 10 and will have the irregular face 32 as illustrated in FIG. 2.

The advantage of using urethane for the forms 10 is that whatever face appearance is desired, the same can be molded into the inside surface of the bottom wall 12 which is not possible if metal forms are used. The process described above may be used to create concrete masonry units, concrete wall blocks, tongue and grove siding products or cultural stone appearance.

A suitable dry-cast concrete product for use in the process of this invention will be comprised of approximately 2.4% by weight water, 21.6% by weight aggregate (sand and gravel) and 15.9% by weight Portland Duracem® F. A suitable compaction pressure is approximately 850 psi.

Thus it can be seen that the invention accomplishes at least all of its stated objectives.

1. A dry-casting method for forming a concrete block having an irregularly surfaced face portion which is partitioned into a plurality of generally rectangular face sections, comprising the steps of:
providing a urethane form including a bottom wall with end and side walls extending upwardly therefrom with each of said walls having an inner surface and with each of said end and side walls having an upper end and with the inner surface of the bottom wall having a plurality of upstanding ribs which define cavity sections therein;
said inner surface of said bottom wall having an irregular surface;
positioning the urethane form in a dry-casting machine;
positioning a hollow mold box, having open upper and lower ends, around said urethane form so that the upper end of the mold box is positioned above the upper ends of the end and side walls of the urethane form and so that the lower end of the mold member is positioned below the upper ends of the end and side walls;
placing dry-cast concrete into the mold box and the urethane form;
compacting the dry-cast concrete in the mold box and the urethane form;
removing the mold box from the compacted concrete and the urethane form;
removing the urethane form and the dry-cast concrete therein from the dry-casting machine;
allowing the dry-cast concrete to cure; and
removing the concrete block from the urethane form.

2. The method of claim 1 wherein at least one coloring agent is placed in the cavity sections prior to the dry-cast concrete being placed therein.

3. The method of claim 1 wherein a first coloring agent is placed into some of said cavity sections and a second coloring agent is placed into some of said cavity sections prior to the dry-cast concrete being placed therein.

4. The method of claim 2 wherein water is also sprayed or sprinkled into the cavity sections after the coloring agent has been placed therein.

5. The method of claim 3 wherein water is also sprayed or sprinkled into the cavity sections after the coloring agents have been placed therein.

6. The method of claim 1 wherein said irregular surface in said bottom is created by molding indentations and ridges therein.

7. The method of claim 1 wherein said irregular surface and said ribs of said bottom are molded therein.

8. The method of claim 1 wherein a pair of urethane forms are positioned on opposite sides of a supporting form member prior to being positioned in the dry-casting machine.

9. The method of claim 1 wherein the dry-casting machine forms a concrete block which has a front to back dimension which is greater than the height of said end and side walls of said urethane form.

10. The method of claim 8 wherein the urethane forms are separated from the supporting form after removal from the dry-casting machine.

11. The method of claim 1 wherein the dry-cast concrete is comprised of approximately 2.4% by weight water, 81% by weight sand and gravel and 15.9% by weight of Portland cement.

12. The method of claim 1 wherein the compacting pressure applied to said dry-cast concrete at approximately 850 psi.

13. The method of claim 1 wherein the dry-cast concrete is also vibrated while the compaction process takes place.

14. A dry-casting method for forming a concrete block having an irregularly surfaced face portion which is partitioned into a plurality of generally rectangular face sections, comprising the steps of:
providing a urethane form including a bottom wall with end and side walls extending upwardly therefrom;
each of said walls having an inner surface;
each of said end and side walls having an upper end;
said inner surface of said bottom wall having an irregular surface;
positioning the urethane form in a dry-casting machine;
positioning a hollow mold box, having open upper and lower ends, around said urethane form so that the upper end of the mold box is positioned above the upper ends of the end and side walls of the urethane form and so that the lower end of the mold box is positioned below the upper ends of the end and side walls;
placing dry-cast concrete into the mold box and the urethane form;
compacting the dry-cast concrete in the mold member and the urethane form;
removing the mold box from the compacted concrete and the urethane form;
removing the urethane form and the dry-cast concrete therein from the dry-casting machine;
allowing the dry-cast concrete to cure; and
removing the concrete block from the urethane form.

15. The method of claim 14 wherein the concrete block is a concrete wall block.

16. A dry-casting method for forming a concrete block having an irregularly surfaced face portion comprising the steps of:
providing a urethane form including a bottom wall with end and side walls extending upwardly therefrom;
each of said walls having an inner surface;
each of said end and side walls having an upper end;
said inner surface of said bottom wall having an irregular surface;
positioning the urethane form in a dry-casting machine;
positioning a hollow mold box, having open upper and lower ends, around said urethane form so that the upper end of the mold box is positioned above the upper ends of the end and side walls of the urethane form and so that the lower end of the mold box is positioned below the upper ends of the end and side walls;
placing dry-cast concrete into the mold box and the urethane form;
compacting the dry-cast concrete in the mold member and the urethane form;
removing the mold box from the compacted concrete and the urethane form;
removing the urethane form and the dry-cast concrete therein from the dry-casting machine;
allowing the dry-cast concrete to cure; and
removing the concrete block from the urethane form.

17. A concrete form which is comprised of a molded urethane material and which has a bottom wall with end and side walls extending upwardly therefrom with the walls having inside surfaces and wherein the inside surface of the bottom wall has an irregular surface molded thereinto.

18. The form of claim 17 wherein said irregular surface is created by indentations and ridges formed in the inside surface of the bottom wall.

19. The form of claim 18 wherein upstanding ribs are also formed in the inside surface of the bottom wall to form a plurality of rectangular cavities.
